(19) United States
(12) Patent Application Publication
(10) Pub. No.: US 2011/0205576 A1
(43) Pub. Date: Aug. 25, 2011

(54) DOCUMENT MANAGEMENT SYSTEM AND METHOD

(76) Inventors: Allison Gaines Parrish Halron, McDonough, GA (US); Senthamarai Kannan Ayyakkannu, West Chester, PA (US)

(21) Appl. No.: 12/884,865

(22) Filed: Sep. 17, 2010

Related U.S. Application Data
(60) Provisional application No. 61/243,296, filed on Sep. 17, 2009.

(51) Int. Cl. G06F 15/00; G06F 17/00; G06F 17/30

(52) U.S. Cl. 358/1.15; 715/273; 707/608; 707/E17.008

(57) ABSTRACT

Described herein is a document management system and method comprising associating a graphic image with document processing information with an electronic document and further processing at least one of the graphic image and electronic document in accordance with the document processing information.

### CROSS REFERENCE TO RELATED PATENT APPLICATION

This application claims priority to U.S. Provisional Application No. 61/243,296 filed Sep. 17, 2009, herein incorporated by reference in its entirety.

### SUMMARY

Described herein is a document management system and method comprising associating a graphic image with document processing information with an electronic document and further processing at least one of the graphic image and electronic document in accordance with the document processing information.

In one aspect, an embodiment of a document management system described herein can be used in a mortgage processing environment to ensure filings are complete, and a mortgage closing is in compliance with federal and state regulations.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates an embodiment of an overview system for practicing aspects of the invention;

FIG. 2 is an illustration of the system architecture according to one embodiment of the present invention;

FIG. 3 is a flowchart illustrating steps that can be performed by the client application according to an embodiment of the invention;

FIG. 4 illustrates operations of a fax receiver/folder monitor service according to an embodiment of the present invention;

FIG. 5 illustrates functions of the scheduler according to one embodiment of the present invention;

FIG. 6 is a block diagram illustrating an exemplary operating environment for performing the disclosed methods; and

FIG. 7 is an illustration of barcodes that can be used to practice an example of an embodiment of the present invention.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Overview

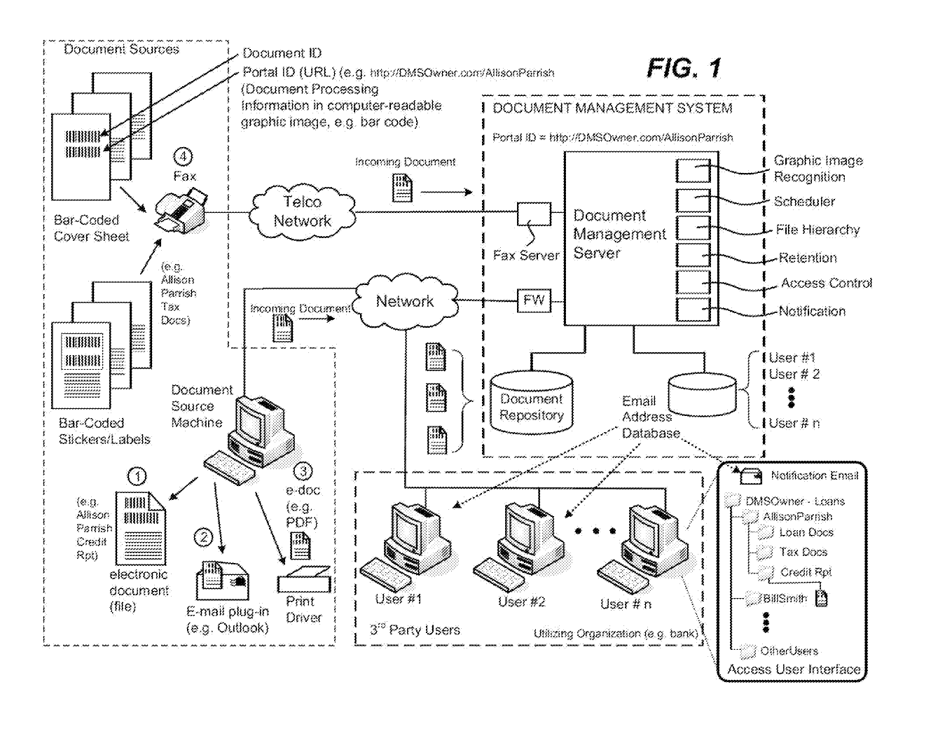

FIG. 1 illustrates an embodiment of an overview system for practicing aspects of the invention. As shown in FIG. 1, documents are provided to a document management system via a variety of document sources. Documents are encoded or associated with document processing information such as, for example, a computer-readable graphic image such as a bar code. Documents are received by the document management system and processed in accordance with their document processing information. Documents can be stored in the document management system and further provided to third-party users in electronic format in accordance with one or more of their document processing instructions, and state or federal laws and guidelines.

### Database

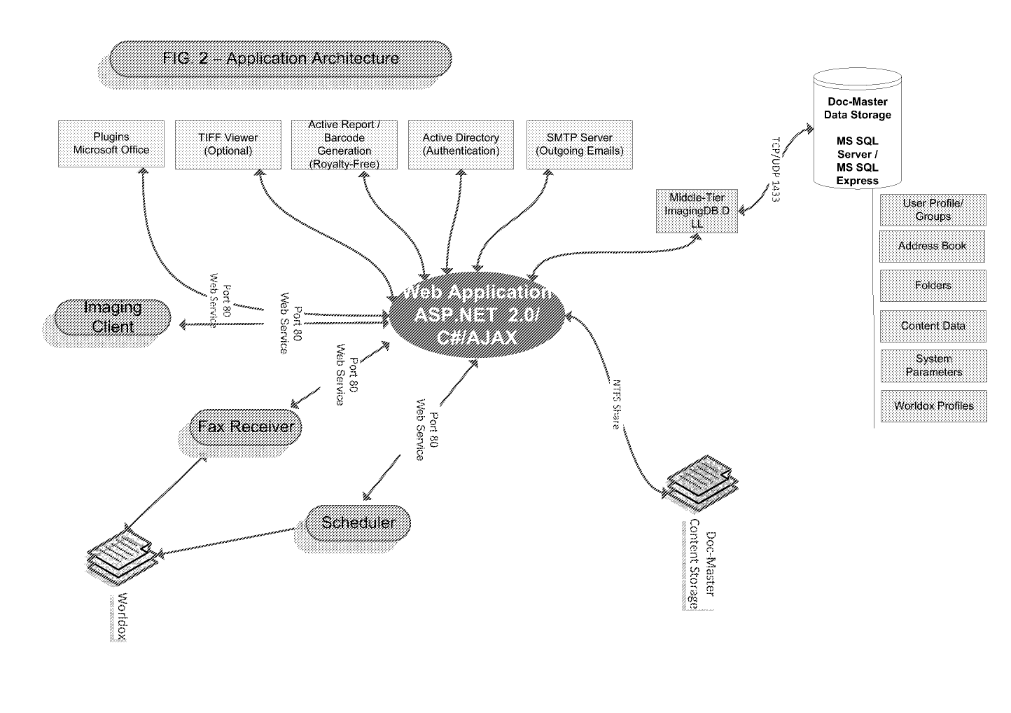

FIG. 2 is an illustration of the system architecture according to one embodiment of the present invention. Comprising this embodiment is an SQL database such as a Microsoft SQL Server database (available from Microsoft Corporation, Mountain View, Calif.), though other types and providers of database products are contemplated with the scope of embodiments of the invention. Generally, the SQL database is used to store data, except documents (files). Passwords or other sensitive information can be stored in an encrypted format (for example, MD5 Hash algorithm) and other data can be stored in pure text format. This database will have link to documents stored in a physical folder. The SQL database can be backed up by an administrator using a web interface.

In one embodiment, files can be stored locally in the local system or on any other storage system like Network Attached Storage (NAS) or Storage Area Network (SAN). MS Network Sharing can be used be used to store the files from the web site or from the fax server to save files. HHTP protocol can be used to display the files over the web site. Files are stored under a folder created with the workflow process name. The file system will not be searched when a user is searching for a file, instead the database will be searched and the database will return the file path to display to the user for a given search criteria. Actual file content is stored in the database to search keywords within the files. For images like TIFF, an OCR component can recognize the whole file content and the content goes into database for searching by keywords. Files are stored in one location only and will not be stored anywhere else. Even, when a file is shared with other customers, the system only sends a link to view the files (with a passcode) and the actual file will not be emailed.

### Web Application

Further comprising the system of FIG. 2 is a web application residing on a server. In one aspect, an embodiment of the web site can be developed using for example Microsoft Visual Studio 2005. The site can run under for example MS Internet Information Server 6.0 or 7.0 with ASP.NET 2.0 or 3.5. As shown in FIG. 2, the web site is the only application that talks to the database. All other applications manage data through the web services hosted within the web application. Each web service is secure and each method in the web service must be called with a valid username/password and these credentials are authenticated and authorized before executing the web service method, which makes the whole web service layer secure. In one aspect, the web site can call MS Active Directory to authenticate users, so that they don't have to remember two passwords, they can login using their Windows username/password. In one aspect, the web site also does regular data management such as, for example, user management, user-group management etc.

a. Workflow Process

An administrator can create workflow processes, which include properties and rules. Any document which comes into this workflow process inherits the properties and rules of the workflow. Properties can be modified at document level and each property will become part of the keyword section of the database. An audit trail is maintained in the database for every change to the property for the purpose of history and security. Workflow properties can include, for example, transaction types such as bank loan, insurance claims, accounting audit, tax return, medical records of a patient; account holder and type of account—business, personal, estate; different loan types—mortgage, commercial loans, acquisition and development, construction, construction to permanent, unsecured consumer credit, equipment, vehicle, line of credit, letter of credit.

Similar to properties, workflow rules can be added to trigger certain events automatically when a user uploads a document or a document property changed or document deleted etc. For example, the system can send a document to the customer when the document property “Status” gets assigned a value of “Processed” or “Rejected.” Also, a workflow process can be linked with one or more user groups. Only those users in the linked user groups can see the workflow during barcode generation or file upload.

b. Print Barcode

In order to fax a document into the system through fax server or automatically upload one or more documents using the client system without manual intervention—there should be a machine-readable identifiers such as, for example, a barcode to identify the customer, document, document properties and web site instance where the user can view the document later.

Before selecting the machine-readable identifier, the customer should select the workflow process and properties of the document. This information will be stored in the database and a unique value associated with the information can be created and incorporated into the machine-readable identifier or associated with a separate machine-readable identifier. For example, the unique value can be coded and printed as barcode along with another barcode, which represents the actual web address.

The barcodes or other machine-readable identifiers uniquely identify some or all of the following information: organization (or company, web site); customer; document; folders and subfolders (if any); and workflow process, which internally identifies properties and rules. Though machine-readable identifiers such as barcodes, maxi-codes, RFID technology, etc. are contemplated with the scope of embodiments of the present invention, generally barcodes are generated using third-party software in Code-128A format.

The machine-readable identifier for “web site address” helps discern a single fax server (described later) for multiple customers (multiple web sites). The fax server reads the barcode or other machine-readable identifier for a web site address and routes the document to appropriate web site.

c. Upload Document

Similar to generating a barcode, the customer can also upload a document without printing a barcode or otherwise associating a machine-readable identifier with the document. At the time of upload, the customer selects a workflow name and document properties, in order to index the document appropriately.

Document properties can be stored in the database along with the document path. The actual document can be stored in the network share.

### Fax Server

In one aspect, the fax server can be a fax receiving application which monitors the output folder configured in the Microsoft Fax Serve (model). Whenever there is a new document arrived into this folder, the fax server reads the machine-readable identifier (e.g., barcode) and routes and indexes the document appropriately to the correct location(s). Sometimes a fax received (or a manually copied scanned document) may contain multiple pages with more than one machine-readable identifier and the application needs to split the document into multiple documents between the machine-readable identifier pages. For example, when there are barcodes on pages 1, 7, 15 and 22, then the application splits the documents into four documents. Pages 1 to 6 are moved to document one, pages 7 to 14 are moved into document two, pages 16 to 21 are moved into document 3, and the rest of the pages are moved into document four.

Though not limited to this embodiment, in one aspect software for reading the machine-readable identifier may only recognize barcodes in certain formats such as, for example, a TIFF document. In such instances, documents received through the fax server are in a TIFF folder. Sometimes the user can copy PDF (scanned) documents into the fax folder, which cannot be processed by the barcode recognizer. So there is another component that converts the PDF document into a TIFF document in order to recognize the barcode. Once the barcode is recognized, then the original PDF file will be uploaded into the document management system and the temporary TIFF file can be deleted.

After uploading the document into the document management system, one or more emails can be sent to, for example, the administrator, customer, or others based on the workflow rules. Also, based on the configuration, the original document will be deleted or moved into another sub folder called, for example, “_processed.”

In one aspect, the fax server can also support one or more digital data lines such as, for example, a T1 line. Whenever a new fax arrives on any time on one of the data lines, the machine-readable identifiers (e.g., barcodes) associated with the fax are read and the documents that comprise the fax are uploaded them to an appropriate site and folder. The system also can perform differently based on the number faxed. For example, each 48 lines in the fax server may have different fax numbers and based on the fax number the system can email the document to any client or upload it into the client's web site. This helps multiple clients sharing one digital data line (e.g., T1 line).

### Client Application

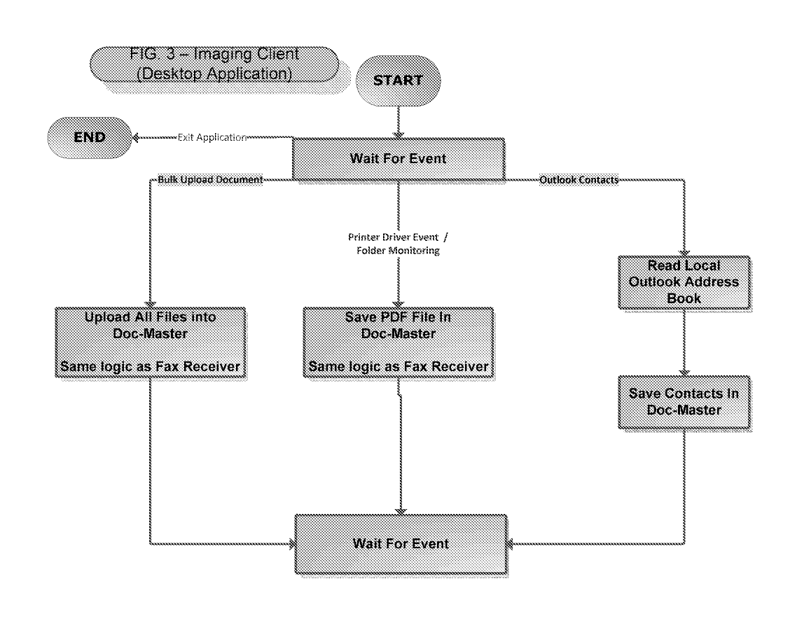

As shown and described herein, embodiments of the system operate using a client-server architecture. For example, in one aspect a client application residing on one computing device connects to a server web site through web services exposed from the web site. Though the client-server architecture generally connects via the Internet, other forms of network connections are contemplated, including private networks, telephone systems, etc. In one aspect, where an Internet connection is used, the web service uses the HTTP Port 80. As shown in FIG. 3, the client application can perform the following tasks through web services: authenticate user to the client application; get workflow and properties; upload documents into the server web site and with other people; upload local outlook contacts into contacts associated with an embodiment of the system, and monitor a folder and upload any documents that come into the folder.

a. Folder Monitoring

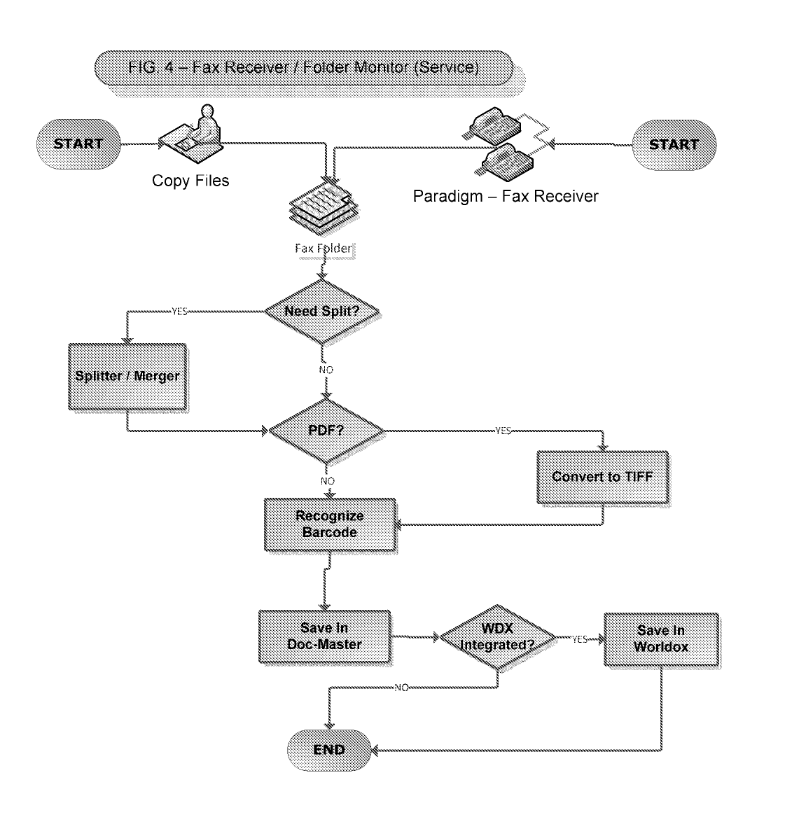

FIG. 4 illustrates operations of a fax receiver/folder monitor service according to an embodiment of the present invention. In one aspect, a client application monitors a specific folder in the local computer and uploads any new documents that arrive into the folder. When a new document arrives, the client application checks for the existence of a barcode or other machine-readable identifier and uploads into a server web site application when there is a barcode or other machine-readable identifier. When there is no barcode or other machine-readable identifier, a module of the client application is executed, so that the user can enter the document properties (e.g., workflow and field values), so that the document can automatically be uploaded and indexed appropriately.

In one aspect, the client application splits the received document into multiple copies when it finds multiple barcodes or other machine-readable identifier in between sheets of the received document and uploads each document as a separate item and indexes the documents based on the barcode value or other machine-readable information. In one aspect, the client application comprises a PDF printer driver (third-party), so that customers can directly print documents into the virtual printer, which can automatically get uploaded into the system's web site.

In one aspect, client installation automatically installs the printer driver along with the client application. When the customer prints any document into this printer driver, it goes into a specific folder, which is monitored by the client application. When the document is placed in the folder, the client application is automatically executed so that the user can enter the properties (workflow and field values) and upload into the system's web site.

### Scheduler

Further comprising an embodiment of the system shown in FIG. 2 is a scheduler. The scheduler performs offline tasks like sending out email etc. For example—one of the rules of a workflow process is “Send email to administrator when the status of a document changes to Rejected”. In the web application, whenever a document gets updated as “Rejected”, it puts a note in the database to send out an email to the administrator. The scheduler keeps checking the email-queue every 5 minutes and sends out anything pending in the queue.

The email portion is made as an offline process to improve the user experience while modifying document properties and the page returns quickly. Sometimes sending an email can take 2 to 10 seconds, but putting a note about the email into the database generally takes less than one second.

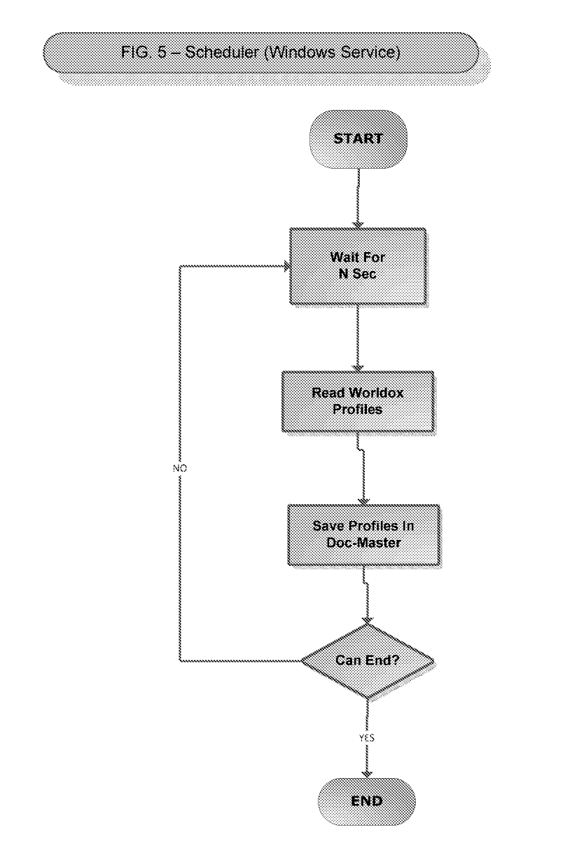

FIG. 5 illustrates functions of the scheduler according to one embodiment of the present invention.

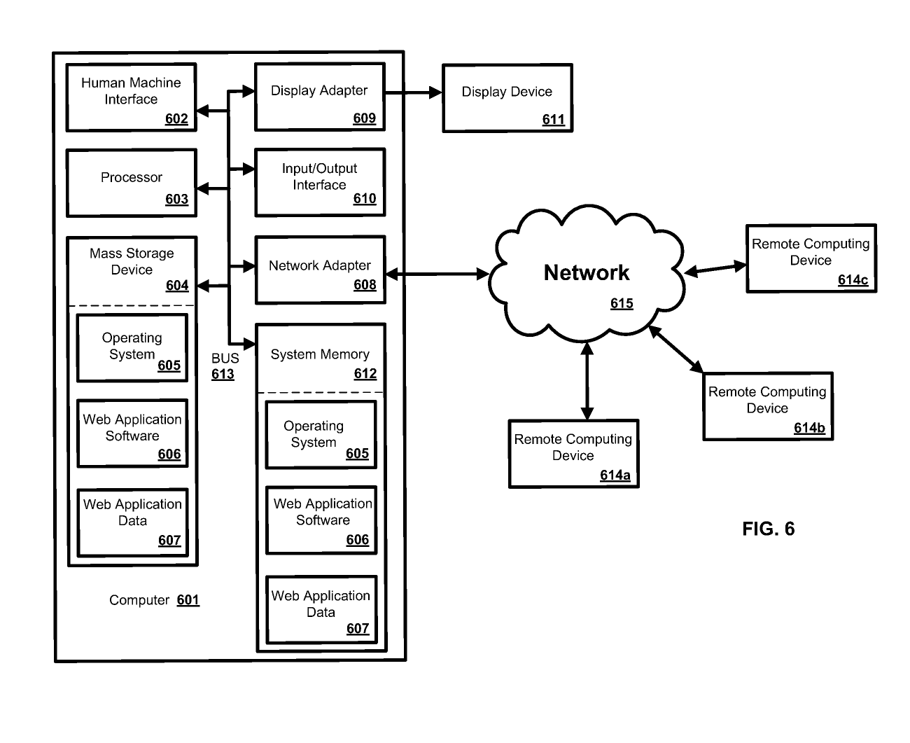

One skilled in the art will appreciate that provided is a functional description and that the respective functions can be performed by software, hardware, or a combination of software and hardware. The methods and systems can comprise the web application Software 606 as illustrated in FIG. 6 and described below. In one exemplary aspect, the units can comprise a computer 601 as illustrated in FIG. 6 and described below.

FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices including mobile devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, web application software 606, web application data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as web application data 607 and/or program modules such as operating system 605 and web application software 606 that are immediately accessible to and/or are presently operated on by the processing unit 603.

In another aspect, the computer 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and web application software 606. Each of the operating system 605 and web application software 606 (or some combination thereof) can comprise elements of the programming and the web application software 606. Web application data 607 can also be stored on the mass storage device 604. Web application data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computer 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like.

The computer 601 can operate in a networked environment using logical connections to one or more remote computing devices 614a,b,c. By way of example, a remote computing device can be a personal computer, portable computer, a server, a router, a network computer, a peer device or other common network node, and so on. Logical connections between the computer 601 and a remote computing device 614a,b,c can be made via a local area network (LAN) and a general wide area network (WAN). Such network connections can be through a network adapter 608. A network adapter 608 can be implemented in both wired and wireless environments. Such networking environments are conventional and commonplace in offices, enterprise-wide computer networks, intranets, and the Internet 615.

For purposes of illustration, application programs and other executable program components such as the operating system 605 are illustrated herein as discrete blocks, although it is recognized that such programs and components reside at various times in different storage components of the computing device 601, and are executed by the data processor(s) of the computer. An implementation of web application software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In an aspect, provided are methods for the remote processing of electronic documents, comprising providing a computer-readable identifier encoding document processing information, the document processing information including (a) a document identifier containing information relating to characteristics of an electronic document, and (b) a portal identifier containing information relating to an electronic processing resource for processing (storage) of the electronic document; associating the computer-readable identifier with an original document that is to be processed as an electronic document; generating an input electronic document comprising an electronic version of the original document together with the computer-readable graphic image; receiving the input electronic document at a document management input system; reading the computer-readable graphic image to derive the document processing information for the input electronic document; determining an electronic document characteristic from the document processing information; routing the input electronic document to the processing resource in accordance with the portal identifier; and processing the input electronic document with the processing resource in accordance with the determined electronic document characteristic.

The remote processing of electronic documents can comprise storage and management of said electronic documents. The computer-readable identifier can comprise a computer-readable graphic image and the associating step can comprise printing of graphic image on a cover sheet to accompany the document for scanning or faxing, printing the graphic image directly on the document for scanning or faxing, printing the graphic image on a label to be affixed to the document for scanning or faxing, printing the graphic image on an electronic version of the document via an electronic print facility (e.g. PDF) for electronic delivery by uploading or email.

The document identifier can comprise customer identification information, document information, and document storage information. The portal identifier can comprise a storage directory pathway or directory; a processing resource at a particular URL. The computer-readable identifier can comprise at least one barcode. The methods can further comprise the step of communicating the input electronic document to a document processing system.

Receiving the input electronic document at a document management input system can comprise having the electronic document faxed in, uploaded; scanned; or emailed. Reading the computer-readable graphic image to derive the document processing information for the input electronic document can comprise document processing information of a document identifier and s portal identifier. The electronic document characteristic can comprise document sharing information, and further comprising the steps of utilizing the document sharing information to establish access control restrictions/abilities for the electronic document indicating that predetermined authorized persons are allowed to access the electronic document; and allowing access to the electronic document by such authorized persons in response to access control means.

The methods can further comprise the steps of storing notification information including the identity and/or email address of a particular person that is to be notified in response to a predetermined condition associated with an electronic document; providing an electronic notification to the particular person with information corresponding to the electronic document; and allowing electronic access by the particular person to the electronic document.

The predetermined condition associated with an electronic document can comprise uploading of document of a particular type and a new document uploaded to a particular folder or location.

The electronic notification can comprise email, text message, popup window or an alert within an application. The electronic notification can comprise information corresponding to availability of the electronic document. The methods can further comprise providing the particular person with document location information (e.g., a URL) to facilitate electronic access. The particular person can comprise one of group of persons notified regarding the electronic document.

The methods can further comprise providing the particular person(s) with a personal identification number (PIN) associated with the electronic document, associating the PIN with the electronic document and its access control information, and allowing access to the electronic document only upon entry of the PIN.

The methods can further comprise the step of associating document PIN persistence information with the electronic document in the processing facility, such that the PIN expires after a predetermined period of time. A document can comprise multiple PINs, to indicate accessibility by multiple different persons. The PIN can be unique to each document.

The methods can further comprise the steps of providing a connection to a contact manager database for a person (e.g. Outlook Contacts); displaying information identifying persons in the contact management database in a user interface; allowing user selection of one or more persons in the displayed information for indicating document sharing, to generate a document sharing list (Notification Group); associating document identification information with entries in the document sharing list; providing a notification message to persons in the document sharing list that includes information (URL) identifying access to the electronic document.

The methods can further comprise displaying information identifying persons in the contact management database in a user interface can comprise displaying names or public email addresses. The methods can further comprise providing a retention period for documents. The methods can further comprise, in response to receipt of an incoming document, storing the document in the appropriate folder, logging the receipt, looking up intended recipients for the document in a database, logging an email request for notification of the intended recipients, passing the request an email engine.

The methods can further comprise the steps of wherein the electronic processing resource is a transaction-oriented master processing resource associated with a predetermined type of transaction; providing a subsidiary processing resource corresponding to particular types of documents that are associated with a transaction of the predetermined type; providing an additional subsidiary processing resource; wherein the electronic document characteristic for an electronic document includes information identifying (a) the predetermined type of transaction, and (b) a particular transaction; in response to the electronic document characteristics in an incoming electronic document, processing the electronic document (e.g. by routing the electronic document for storage) in accordance with (a) the master processing resource, (b) as qualified by the subsidiary processing resource, and (c) as further qualified by the additional subsidiary processing resource.

The transaction-oriented master processing resource can comprise a master directory for storage and the predetermined type of transaction includes a bank loan, insurance claim, accounting audit, tax return; medical records of a patient. The subsidiary processing resource can comprise a subdirectory for document types within a master transaction type. The methods can further comprise providing an additional subsidiary processing resource can comprise providing a subdirectory for a particular transactions, e.g. a “Loan to Person X.” In an aspect, a particular transaction can be first, then types within the particular transaction.

The methods can further comprise the steps of wherein the processing resource is a master processing resource associated with a particular person; providing a subsidiary processing resource corresponding to particular types of documents for processing/storage on behalf of the particular person; wherein the electronic document characteristic for an electronic document includes information identifying (a) the particular person, and (b) a particular document type; in response to the electronic document characteristics in an incoming electronic document, processing the electronic document by routing the electronic document for storage in (a) the master processing resource, further qualified by (b) the subsidiary processing resource.

The master processing resource can comprise a master directory for storage associated with a particular person. The methods can further comprise providing a subsidiary processing resource can comprise providing a subdirectory for document types set up by the particular person corresponding to particular types of documents for processing/storage on behalf of the particular person. The methods can further comprise notification aspects e.g. to person's accountant, lawyer, etc. The methods can further comprise access control aspects to allow access control to particular documents in particular subdirectories, etc. The methods can further comprise a further subsidiary processing resource, e.g. further nested directories with document types, or as established by person.

In another aspect, for use in connection with a document processing system that is responsive to electronic receipt of an input electronic document in association with a computer-readable graphic image containing document processing information, provided are methods and systems for generating the computer-readable graphic image and associating same with an electronic document, comprising the steps of: displaying a user interface to a user of a network-accessible user's computer for purposes of user entry of document processing information and selection of a target document for processing by the document processing system; providing an input for user entry of document processing information for association with the target document; processing the entered document processing information to generate a computer-readable graphic image encoding the document processing information; associating the generated computer-readable graphic image encoding the document processing information with the target electronic document; and communicating the associated computer-readable graphic image encoding the document processing information and the target electronic document to the document processing system for processing in accordance with the document processing information.

The methods can further be used in connection with a remote document processing system. The methods can further be used in connection with a network-accessible document processing system. Document processing information can comprise one or more of a document identifier and a portal identifier.

The associating step can comprise printing of graphic image on a cover sheet to accompany the document for scanning or faxing, printing the graphic image directly on the document for scanning or faxing, printing the graphic image on a label to be affixed to the document for scanning or faxing, printing the graphic image on an electronic version of the document via an electronic print facility (e.g. PDF) for electronic delivery by uploading or email.

In a further aspect, provided are methods and systems for executing a document retention policy with respect to electronic documents stored in a document management system (DMS), in which a plurality of electronic documents each have a retention period within the DMS as determined by document type information, and in which documents are stored in a directory in the DMS identified by document type, and in which documents each possess document creation metadata, comprising the steps of executing a scheduler program at predetermined intervals to access a target directory of a particular type, the scheduler program carrying out the steps of accessing the metadata of each electronic document within the target directory to determine the creation date of each document; comparing the creation date of each document in the target directory, in response to identification of an electronic document within the target directory having a creation date that results in a time exceeding the retention period for documents of that particular type, generating a log identifying the pathname and filename of the documents that are candidates for deletion; with the log, generating a notification to a retention manager that documents meeting the criteria for deletion will be deleted (or archived) within a predetermined period; and in response to determination that the documents are not to be retained, deleting or archiving the documents.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

For example, two separate companies, Company A and Company B are using an embodiment of the present invention and have web access through URLs http://A.paradigmbusinesssolutions.com, and http://B.paradigmbusinesssolutions.com respectively.

Company A uses an embodiment of the present invention for HR related activities and each document in their system can have, for example, the following properties: Employee Name; Employee Id; Address; and SSN.

Company B uses an embodiment of the present invention to manage its car loans with the following document properties: Customer Name; Account Id; VIN Number; and, Loan Id.

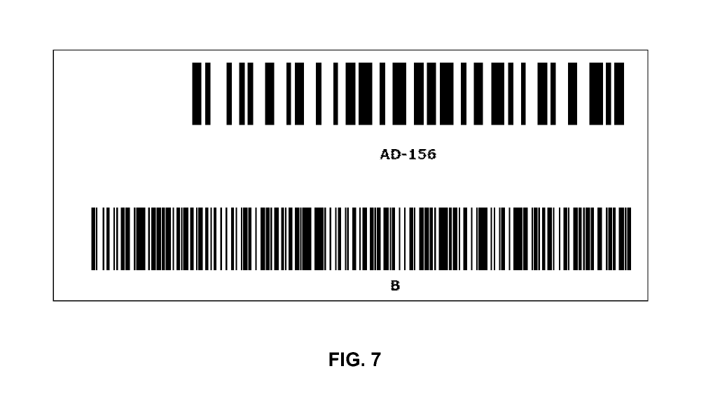

In both instances, every (HR or Loan) document stored in an embodiment of the present invention will have a machine-readable identifier (e.g., a barcode), which uniquely identifies each document. Documents can be entered into the system in one of the following four ways:
a. the customers or the employees of Company A or Company B can upload documents into the system by manually entering the properties of the documents. For example, an employee of Company A will enter employee Name, Id, Address and SSN before uploading the document.
b. the customers or the employees of Company A or Company B can print a barcode by entering the document properties and fax a document by keeping the barcode as the cover page. In this case, the system generates a unique id in the system and prints one page document with two barcodes, one identifying the company and the other one identifying the document properties entered. In the following example, the system creates a unique id (AD-156) for the loan information entered and prints this value as barcode as shown in FIG. 7. Also, the second barcode identifies the company name. When the fax server receives the document, it finds the web site by looking at the second barcode and the mapping between company codes (B) and company web address (http://B.paradigmbusinesssolutions.com). Then it communicates to the web site using web services, to find out the document properties entered during barcode creation. Finally, it uploads the document into the web site and indexes the document with the pre-entered document properties. This process enables a single fax server to serve multiple customers. In this example, AD-156, also uniquely identifies, the customer, the car and the loan.
c. The employees of companies A or B can print a barcode by entering the document properties; scan a document by keeping the barcode as the first page and copy into the fax server folder. The fax server will pick-up any new document copied into the fax folder and applies the same logic defined in the above step.
d. The employees of companies A or B can print documents into a local printer driver, which automatically opens the client application to enter the document properties and finally it uploads the documents into the customer web site with document property

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for the remote processing of electronic documents, comprising the steps of:
providing a computer-readable identifier encoding document processing information, the document processing information comprising (a) a document identifier containing information relating to characteristics of an electronic document, and (b) a portal identifier containing information relating to an electronic processing resource for processing (storage) of the electronic document;
associating the computer-readable identifier with an original document that is to be processed as an electronic document;
generating an input electronic document comprising an electronic version of the original document together with the computer-readable graphic image;
receiving the input electronic document at a document management input system;
reading the computer-readable graphic image to derive the document processing information for the input electronic document;
determining an electronic document characteristic from the document processing information;
routing the input electronic document to the processing resource in accordance with the portal identifier; and
processing the input electronic document with the processing resource in accordance with the determined electronic document characteristic.

2. The method of claim 1, wherein remote processing of electronic documents comprises storage and management of said electronic documents.

3. The method of claim 1, wherein the computer-readable identifier comprises a computer-readable graphic image and the associating step comprises:
printing of graphic image on a cover sheet to accompany the document for scanning or faxing, printing the graphic image directly on the document for scanning or faxing, printing the graphic image on a label to be affixed to the document for scanning or faxing, printing the graphic image on an electronic version of the document via an electronic print facility (e.g. PDF) for electronic delivery by uploading or email.

4. The method of claim 1, wherein the document identifier comprises customer identification information, document information, and document storage information.

5. The method of claim 1, further comprising the step of communicating the input electronic document to a document processing system.

6. The method of claim 1, wherein reading the computer-readable graphic image to derive the document processing information for the input electronic document comprises document processing information of a document identifier and s portal identifier.

7. The method of claim 1, wherein the electronic document characteristic comprises document sharing information, and further comprising the steps of:
utilizing the document sharing information to establish access control restrictions/abilities for the electronic document indicating that predetermined authorized persons are allowed to access the electronic document; and
allowing access to the electronic document by such authorized persons in response to access control means.

8. The method of claim 1, further comprising the steps of:
storing notification information comprising the identity and/or email address of a particular person that is to be notified in response to a predetermined condition associated with an electronic document;
providing an electronic notification to the particular person with information corresponding to the electronic document; and
allowing electronic access by the particular person to the electronic document.

9. The method of claim 8, further comprising providing the particular person(s) with a personal identification number (PIN) associated with the electronic document, associating the PIN with the electronic document and its access control information, and allowing access to the electronic document only upon entry of the PIN.

10. The method of claim 8, further comprising the steps of:
providing a connection to a contact manager database for a person;
displaying information identifying persons in the contact management database in a user interface;
allowing user selection of one or more persons in the displayed information for indicating document sharing, to generate a document sharing list;
associating document identification information with entries in the document sharing list; and
providing a notification message to persons in the document sharing list that comprises information (URL) identifying access to the electronic document.

11. The method of claim 1, further comprising the steps of:
wherein the electronic processing resource is a transaction-oriented master processing resource associated with a predetermined type of transaction;
providing a subsidiary processing resource corresponding to particular types of documents that are associated with a transaction of the predetermined type;
providing an additional subsidiary processing resource;
wherein the electronic document characteristic for an electronic document comprises information identifying (a) the predetermined type of transaction, and (b) a particular transaction; and
in response to the electronic document characteristics in an incoming electronic document, processing the electronic document (e.g. by routing the electronic document for storage) in accordance with (a) the master processing resource, (b) as qualified by the subsidiary processing resource, and (c) as further qualified by the additional subsidiary processing resource.

12. The method of claim 11, wherein the transaction-oriented master processing resource comprises a master directory for storage and the predetermined type of transaction comprises a bank loan, insurance claim, accounting audit, tax return; medical records of a patient.

13. The method of claim 1, further comprising the steps of:
wherein the processing resource is a master processing resource associated with a particular person;
providing a subsidiary processing resource corresponding to particular types of documents for processing/storage on behalf of the particular person;
wherein the electronic document characteristic for an electronic document comprises information identifying (a) the particular person, and (b) a particular document type;
in response to the electronic document characteristics in an incoming electronic document, processing the electronic document by routing the electronic document for storage in (a) the master processing resource, further qualified by (b) the subsidiary processing resource.

14. The method of claim 13, wherein providing a subsidiary processing resource comprises providing a subdirectory for document types set up by the particular person corresponding to particular types of documents for processing/storage on behalf of the particular person.

15. A method for generating the computer-readable graphic image and associating same with an electronic document, comprising the steps of:
displaying a user interface to a user of a network-accessible user's computer for purposes of user entry of document processing information and selection of a target document for processing by the document processing system;
providing an input for user entry of document processing information for association with the target document;
processing the entered document processing information to generate a computer-readable graphic image encoding the document processing information;
associating the generated computer-readable graphic image encoding the document processing information with the target electronic document; and
communicating the associated computer-readable graphic image encoding the document processing information and the target electronic document to the document processing system for processing in accordance with the document processing information.

16. The method of claim 15, for use in connection with a remote document processing system.

17. The method of claim 15, for use in connection with a network-accessible document processing system.

18. The method of claim 15, wherein document processing information comprises one or more of a document identifier and a portal identifier.

19. The method of claim 15, wherein the associating step comprises: printing of graphic image on a cover sheet to accompany the document for scanning or faxing, printing the graphic image directly on the document for scanning or faxing, printing the graphic image on a label to be affixed to the document for scanning or faxing, printing the graphic image on an electronic version of the document via an electronic print facility (e.g. PDF) for electronic delivery by uploading or email.

20. A method for executing a document retention policy with respect to electronic documents stored in a document management system (DMS), in which a plurality of electronic documents each have a retention period within the DMS as determined by document type information, and in which documents are stored in a directory in the DMS identified by document type, and in which documents each possess document creation metadata, comprising the steps of:
executing a scheduler program at predetermined intervals to access a target directory of a particular type, the scheduler program carrying out the steps of:
accessing the metadata of each electronic document within the target directory to determine the creation date of each document;
comparing the creation date of each document in the target directory, in response to identification of an electronic document within the target directory having a creation date that results in a time exceeding the retention period for documents of that particular type, generating a log identifying the pathname and filename of the documents that are candidates for deletion;
with the log, generating a notification to a retention manager that documents meeting the criteria for deletion will be deleted (or archived) within a predetermined period; and
in response to determination that the documents are not to be retained, deleting or archiving the documents.
